(19) United States
(12) Patent Application Publication
(10) Pub. No.: US 2012/0067161 A1
(43) Pub. Date: Mar. 22, 2012

(54) MECHANICAL ASSIST FOR PNEUMATIC VALVE ACTUATORS

(76) Inventor: Paul Stephen Shirley, Indianapolis, IN (US)

(21) Appl. No.: 12/887,078

(22) Filed: Sep. 21, 2010

(51) Int. Cl. F16K 31/60; B23P 11/00

(52) U.S. Cl. 74/523; 29/426.2

(57) ABSTRACT

A valve actuator assist system, including a first elongated generally flat portion, an aperture formed through the first generally flat portion for loosely engaging a knob member, a second generally flat portion, an axis-engaging u-section connected to first and second generally flat portions, an elongated axial rod positioned in the axis-engaging u-section, and a bracket engaged positioned adjacent the axis-engaging u-section and connected to the axial rod. The axis-engaging u-section is engaged to the axis member and the first and second generally flat portions are at an angle between 155 and 170 degrees.

### TECHNICAL FIELD

The novel technology relates generally to the field of mechanical engineering and, specifically, to a device for assisting a vehicle operator in actuating pneumatic valves.

### BACKGROUND

Carpal tunnel syndrome (CTS) is a condition that is caused by the compression of the median nerve through the carpal tunnel which is located on the palm side of the wrist. Compression of the nerve can cause pain or numbness in the arm which may reach into the shoulder and neck area. CTS is often associated with office work where long hours are spent in front of a computer keyboard. However, it is not the use of the keyboard that causes the compression, but rather the use of repetitive action in the activity. The trucking industry is one such industry with a common incidence of CTS related injuries. The repetitive nature of the job can cause CTS and other repetitive stress injuries. A problem area in the trucking industry is the use of pneumatic air brake systems that include brake valves located in the cab. The driver manipulates these valves by pulling the valve out to actuate and pushing in to deactuate, or, in some cases, by pushing the valve in to actuate and pulling the valve out to deactuate. The gripping of the valve cap to pull the valve toward the driver requires significantly more force than the pushing in of the same valve and the repetitive nature of the act is very stressful on the wrist and hands and can lead to CTS and other repetitive stress injuries. This issue is exacerbated by drivers having the job of driving vehicles around a yard or loading dock, wherein the drivers are constantly and repetitively actuating and deactuating the pneumatic valves.

There is thus a need for a mechanical assist system that assists a driver in repeatedly pulling out pneumatic control valves in order to reduce instances of CTS and other repetitive stress injuries. The present invention addresses this need.

### SUMMARY

The present novel technology relates to a mechanism for assisting a vehicle operator in actuating pneumatic valves. One object of the present application to provide an improved pneumatic valve system. Related objects and advantages of the present novel technology will be apparent from the following description.

### BRIEF DESCRIPTION OF THE DRAWINGS

FIG. 1 is a perspective view of a first embodiment valve actuator assist device of the present novel technology.

FIG. 2 is a top plan view of FIG. 1

FIG. 3 is a side elevation view of FIG. 1.

FIG. 4 is a partial cutaway side elevation view of the embodiment of FIG. 1 as engaged to a valve actuator.

FIG. 5 is an exploded view of the embodiments of FIG. 1 and FIG. 6 as engaged to valve actuators.

FIG. 6 is a top plan view of second embodiment valve actuator assist device of the present novel technology.

FIG. 7 is a side elevation view of FIG. 6.

FIG. 8 is a perspective view of FIG. 6.

### DETAILED DESCRIPTION

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

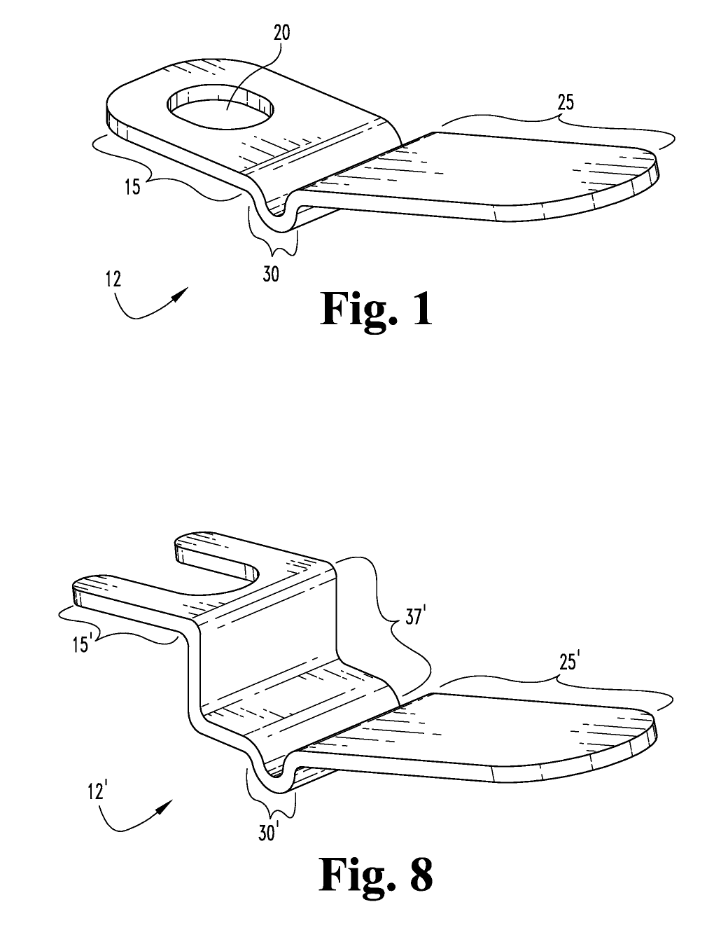

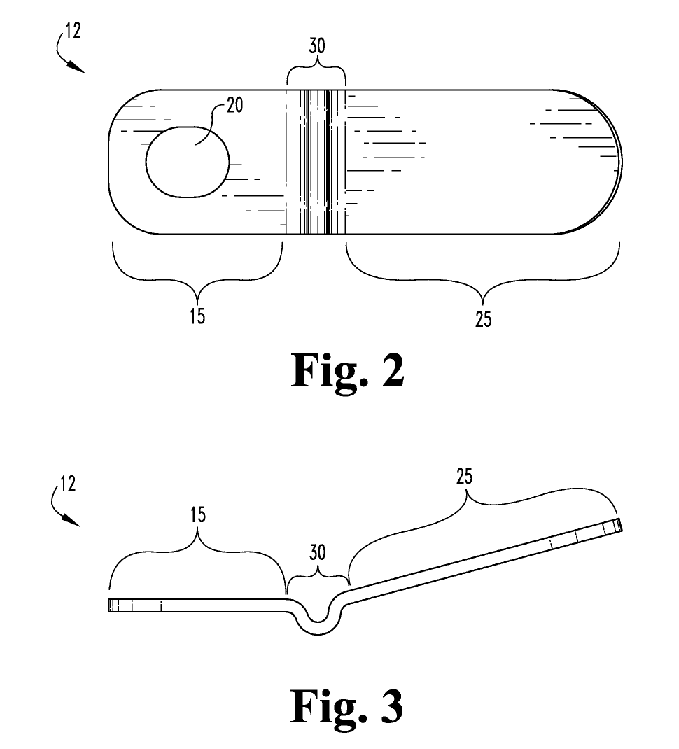

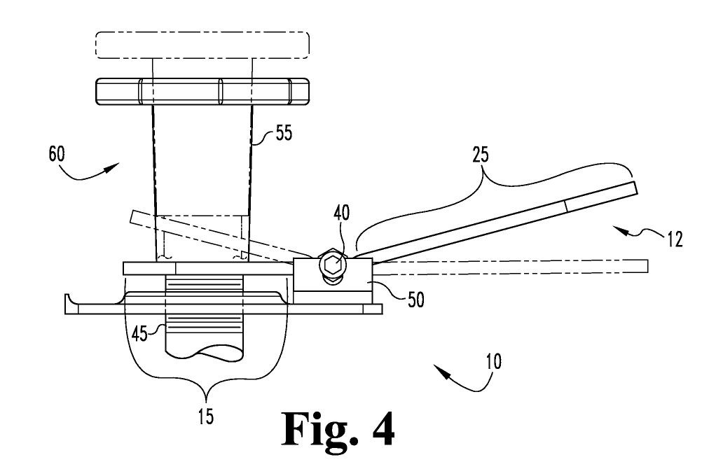

FIGS. 1-5 illustrate a first embodiment of the present novel technology, a system 10 for allowing both actuation and deactuation of pneumatic valves with a pushing motion. The valve actuator assist system 10 includes generally flat lever member 12, having a first generally flat portion 15 containing a typically generally circular aperture 20, although the aperture may have any convenient shape, such as oval, octagonal, or the like, and may either be closed or open. The first generally flat portion 15 is connected to the second generally flat portion 25 typically through an axis-engaging u-section 30 which typically engages a pivoting axis member 35. The first generally flat portion 15 and second generally flat portion 25 are typically positioned to define an angle of about 155-175 degrees, more typically of about 160-170 degrees and still more typically of about 165 degrees. The axis member 35 is typically held in place by a connecter portion 40, such as a screw and nut combination, or the like. A bracket portion 50 is typically connected to the axis member 35, likewise by the connector portion 40.

The lever member 12 is typically attached to a vehicle dash plate by the bracket portion 50, such as by bolting, gluing or otherwise fastening the bracket portion 50 to the dash, or, more typically, an anchor portion 70, such as the top portion of a pneumatic valve assembly. A knob member 55 is typically removed from a valve actuator 60 to expose a generally cylindrical shaft member 45 and the generally circular aperture 20 of the first generally flat portion 15 is typically positioned around the generally cylindrical shaft member 45. The knob member 55 is then replaced for operation of the valve actuator 60.

In operation, the pneumatic brake is engaged by pushing the knob member 55 downward. Ordinarily, the brake is disengaged by pulling the knob member in an upwardly direction; instead, the second generally flat portion 25 is pushed downward by the operator, urging the first generally flat portion 15 to travel upwardly, engage the knob member 55, and likewise urge the knob member 55 upwardly, disengaging the brake.

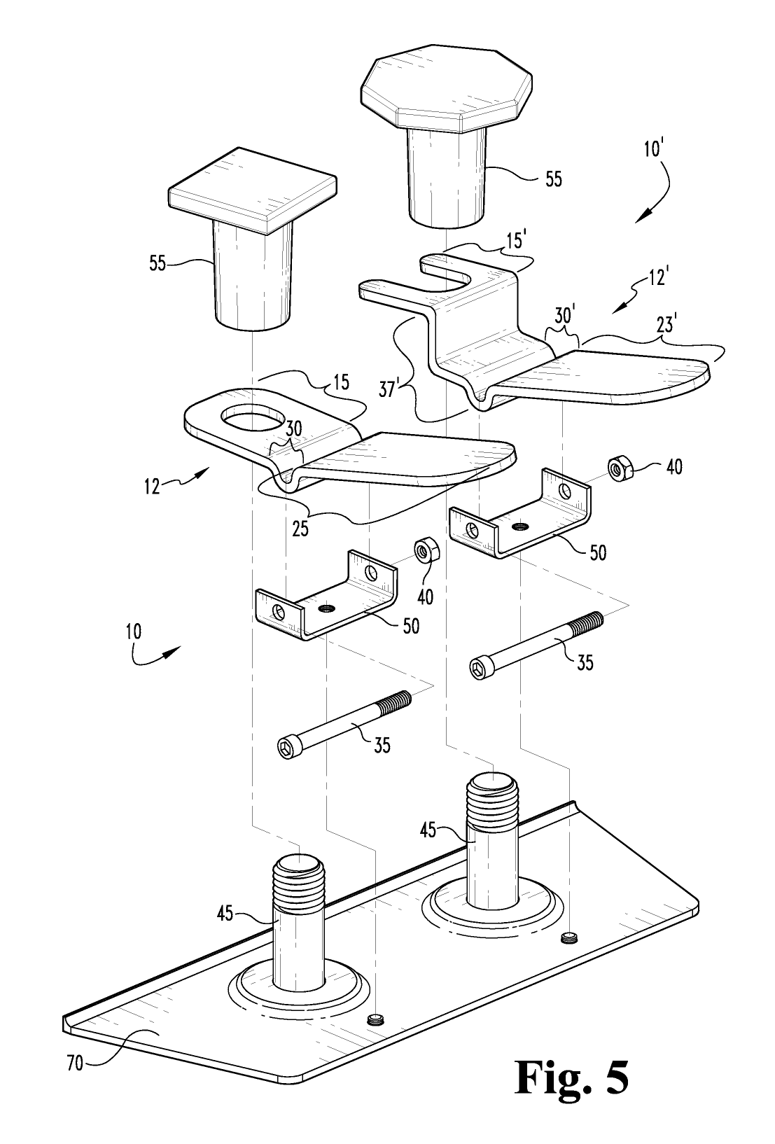

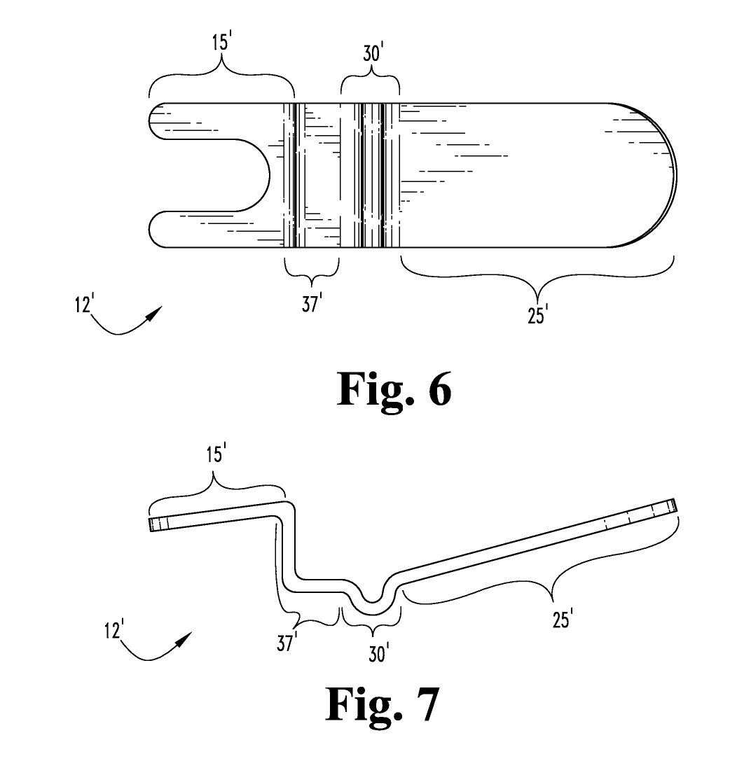

FIGS. 5-8 illustrate an alternate embodiment system 10′, similar to that shown in FIGS. 1-5, but wherein the first generally flat portion 15′ is connected to the second generally flat portion 25′ through an axis engaging u-shaped portion 30′ connected to the second generally flat portion 25′ with a generally L-shaped portion 37′ extending from the axis-engaging u-shaped portion 30′ and connecting to the first generally flat portion 15′. Also, the aperture 20′ formed in the generally flat portion 15′ is shown to be an open-ended oval, but may have any convenient open or closed shape. When engaged to the vehicle via axis member 35′, connector portion 40′ and bracket 50′, and likewise engaged to the valve shaft member 45 and knob member 55, L-shaped portion 37′ extends away from the bracket 50′ towards the knob member 55, thus engaging knob member 55 nearer the top of shaft 45. In operation, system 10′ functions substantially the same as system 10 as described above.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. A method of assisting an operator in actuating a push-pull type pneumatic valve parking brake, comprising:
removing a knob member from a valve actuator to expose a shaft member extending from a vehicle dash plate;
positioning a first generally flat member around the shaft member;
securing a pivoting axis to the vehicle dash plate;
replacing the knob member;
pushing downwardly on a second generally flat member connected to the first generally flat member at the pivoting axis to urge the first generally flat member upward to engage the knob member;
wherein the first and second flat members connect to define an axis-engaging portion having a generally u-shaped cross-section; and
wherein the pivoting axis is positioned in the axis-engaging portion.

2. A valve actuator assist system, comprising:
a first elongated generally flat portion;
an aperture formed through the first generally flat member for loosely engaging a knob member;
a second generally flat portion;
an axis-engaging u-section connected to first and second generally flat members;
an elongated axial rod positioned in the axis-engaging u-section;
a bracket engaged positioned adjacent the axis-engaging u-section and connected to the axial rod;
wherein axis-engaging u-section is engaged to the axis member;
wherein the first and second generally flat portions are disposed to define an angle between 155 and 170 degrees.

3. The valve actuator assist system of claim 2 wherein the bracket is attached to a vehicle dash plate; wherein the valve shaft extends through the aperture; and wherein a valve knob is connected to the end of the valve shaft.

4. The valve actuator assist system of claim 2 wherein the first generally flat portion includes a first generally planar portion extending away from the axis-engaging u-section; a second generally planar portion oriented generally parallel to the first generally planar portion; and a third portion extending between the first and second generally planar portions.

5. The valve actuator assist system of claim 4 wherein the first and second generally planar portions are non-coplanar.

6. The valve actuator assist system of claim 2 wherein the first and second generally flat portions are disposed to define an angle of about 165 degrees.

7. An assembly for assisting a vehicle operator with the actuation and/or deactuation of valves, comprising:
an anchor portion having a valve shaft extending therefrom;
a generally flat member pivotably connected to the anchor portion and further comprising:
a first generally flat portion;
an aperture formed through the first generally flat portion;
a second generally flat portion; and
a recessed portion having a generally U-shaped cross-section connected to the first generally flat portion and connected to the second generally flat portion;
wherein the first and second generally flat portions define an angle of between about 155 and about 157 degrees;
an elongated cylindrical member disposed in the recessed portion;
a bracket connected to the elongated cylindrical member and connected to the anchor portion; and
a valve cap operationally connected to the valve shaft;
wherein the valve shaft extends through the aperture;
wherein depression of the second generally flat portion urges the first generally flat portion into contact with the valve cap; and
wherein upon depression of the second generally flat portion, the first generally flat portion urges the valve cap to travel away from the anchor portion.
